(19) United States
(12) Patent Application Publication
(10) Pub. No.: US 2014/0217022 A1
(43) Pub. Date: Aug. 7, 2014

(54) NOVEL IN-SITU MEMBRANE CLEANING USING PERIODIC ELECTROLYSIS

(71) Applicant: Masdar Institute of Science and Technology, Abu Dhabi (AE)

(72) Inventors: Raed Hashaikeh, Abu Dhabi (AE); Boor Lalia, Abu Dhabi (AE); Nidal Hilal, Swansea (GB)

(73) Assignee: Masdar Institute of Science and Technology, Abu Dhabi (AE)

(21) Appl. No.: 14/169,764

(22) Filed: Jan. 31, 2014

Related U.S. Application Data
(60) Provisional application No. 61/759,749, filed on Feb. 1, 2013.

(51) Int. Cl. B01D 65/02; C02F 1/44

(52) U.S. Cl. CPC B01D 65/02; C02F 1/441; C02F 1/442; C02F 1/447; C02F 1/444
USPC 210/636; 210/243

(57) ABSTRACT

A membrane is provided herein having the ability to remove/prevent membrane fouling. This novel membrane consists of a thin electrically conductive layer deposited on the membrane surface. This unique membrane can be used as an electrode in an electrochemical system that consists of the membrane, the salty water as an electrolyte and a counter electrode that can be inserted in the saline feed solution. A periodic electrolysis can be performed. Electrolysis will generate gases (e.g., Cl₂ and O₂) and the periodic gases evolution at the membrane surface acts to clean and prevent both fouling and scaling of the membrane surface. The new system enables on-line self-cleaning mechanism of the membrane, which is useful for, inter alia, use of such a membrane in a system for the desalination of saline water or wastewater.

### BACKGROUND

All types of membranes, such as reverse osmosis (RO), nanofiltration (NF), membrane distillation (MD), microfiltration (MF), ultrafiltration (UF), etc., used in water technologies including desalination suffer fouling from both organic and inorganic compounds. This includes scaling and deposition of biological materials on the membrane surface leading to a huge reduction in efficiency.

The degradation of membrane performance due to fouling and scaling is a major concern for these membrane processes in desalination, water and wastewater treatment technologies. The membrane degradation involves the deposition of organic/inorganic/biological materials on the surface/inside the porous structure of membrane. Al-Ahmad et al., Biofuoling in RO membrane systems Part 1: Fundamentals and control, Desalination, 132 (2000) 173-179; Bai et al., Microfiltration of activated sludge wastewater—the effect of system operation parameters, Separation and Purification Technology, 29 (2002) 189-198; Nilsson et al., Protein fouling of uf membranes: Causes and consequences, Journal of Membrane Science, 52 (1990) 121-142; Goosen et al., Fouling of Reverse Osmosis and Ultrafiltration Membranes: A Critical Review, Separation Science and Technology, 39 (2005) 2261-2297; Hon et al., Bacterial adhesion: From mechanism to control, Biochemical Engineering Journal, 48 (2010) 424-434; Taniguchi et al., Modes of Natural Organic Matter Fouling during Ultrafiltration, Environmental Science & Technology, 37 (2003) 1676-1683.

A periodic regeneration of the membranes is important to sustain the water flux through the membrane with passage of time. A number of physical and chemical techniques are used for membrane regeneration/cleaning. These techniques include liquid backwashing, pulsing, forward flushing with air, sonification, chemical washing etc. Hilal et al., Methods Employed for Control of Fouling in MF and UF Membranes: A Comprehensive Review, Separation Science and Technology, 40 (2005) 1957-2005; Ahmad et al., Membrane Antifouling Methods and Alternatives: Ultrasound Approach, Separation & Purification Reviews, 41 (2012) 318-346; Majamaa et al., Three steps to control biofouling in reverse osmosis systems, Desalination and Water Treatment, 42 (2012) 107-116.

In most of the cleaning processes, membranes/modules must to be taken out of setup and treated using various methods. During the cleaning process, the water treatment setup shuts down and requires additional infrastructure. Membrane cleaning processes add to the operational cost of the water treatment plants.

Thus, improved methods for cleaning the membranes are needed.

### BRIEF SUMMARY OF EMBODIMENTS

Provided herein is an in-situ cleaning system of a membrane using an electrolysis process. The membrane is coated or impregnated with an electrically conductive material and acts as an electrode during the electrolysis process. The electrochemical reactions at the membrane surface helps to remove the deposited foulants on the membrane.

Also provided is a system useful for desalination of an electrolyte such as saline water or wastewater, comprising: a) at least two separate compartments having a semipermeable membrane situated therebetween, with one of said compartments configured for containing said electrolyte, and the other of said compartments configured for containing or collecting desalinated water; b) an electrically conductive layer on or in said membrane; c) a power source connected to said conductive layer and configured so that said conductive layer is an anode; and d) an electrode connected to said power source, with said electrode configured to be in fluid communication with said electrolyte, and with said power source configured so that said electrode is a cathode, whereby application of a voltage difference between said anode and said cathode in the presence of said electrolyte generates a gas that cleans said membrane.

In some embodiments, the membrane is a reverse osmosis, nanofiltration, membrane distillation, microfiltration, or ultrafiltration membrane.

In some embodiments, the system further comprises a controller operatively associated with said power source.

In some embodiments, the conductive layer is configured to be in fluid communication with the electrolyte.

Further provided is a method of cleaning a desalination membrane, comprising: providing an anode on said membrane, said anode in fluid communication with an electrolyte solution; providing a cathode, wherein said cathode is also in fluid communication with said electrolyte solution; and applying a voltage difference between said anode and said cathode to produce a gas on said anode sufficient to clean said membrane.

In some embodiments, the electrolyte solution is saline water or wastewater.

In some embodiments, the gas comprises oxygen and/or chlorine gas.

In some embodiments, the membrane is fouled by a biofilm coating thereon, and said gas is sufficient to remove at least a portion of said biofilm. In some embodiments, the portion is at least 10, 20, 30, 40 of 50% of said biofilm coating (by weight, surface area, etc.).

### BRIEF DESCRIPTION OF THE DRAWINGS

FIG. 1 shows components of an electrochemical system integrated with a desalination module.

FIG. 2 is a scanning electron micrograph of the MWCNTs coated membrane.

FIG. 3 is an optical image of fouled membrane kept in waste water for 24 hours.

FIG. 4 shows (a) schematic of setup used for electrolysis and (b) current-time characteristics of electrolysis.

FIG. 5 shows optical images of the fouled membrane before and after electrolysis.

### DETAILED DESCRIPTION OF EMBODIMENTS

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

A “desalination” system, as known in the art, is a system useful to remove salts and/or other impurities from a liquid such as water. Desalination is useful, for example, to produce fresh water from salt water from the ocean, or to treat wastewater. The term “saline” or “saline solution,” as used herein, refers to aqueous mixtures including dissolved salts. Saline solutions include, but are not limited to, brackish water, saline water, and brine.

The term “wastewater” as used herein, refers to water containing organic material, particularly aqueous waste disposed from domestic, municipal, commercial, industrial and agricultural uses. For example, wastewater includes human and other animal biological wastes, and industrial wastes such as food processing wastewater.

Some methods of desalination make use of membranes in order to separate the water from the salts or other impurities. Any suitable membrane may be used. Examples of such membranes include, but are not limited to, those useful for reverse osmosis (RO), nanofiltration (NF), membrane distillation (MD), microfiltration (MF), ultrafiltration (UF), etc., which membranes are known in the art. For example, membranes may be made from graphene (see U.S. 2013/0015136 to Bennett), polyimine (see U.S. 20120322119), polyamide (see U.S. 20120255898), other semipermeable polymers, etc.

The term “reverse osmosis membrane,” as used herein, refers to any semi-permeable membrane capable of blocking solute particles having a size of about 0.0001 microns or larger including, but not limited to, monovalent salts, ions, sugars, proteins, emulsions, viruses, and/or bacteria. In the RO process, high pressures are used to drive the solvent (water) through the membrane (see U.S. 20120255898).

The term “microfiltration membrane” refers to any semipermeable membrane capable of blocking solute particles having a size of about 0.1 microns or larger including, but not limited to, monovalent salts, ions, sugars, proteins, emulsions, viruses, and/or bacteria.

The term “ultrafiltration membrane” refers to any semipermeable membrane capable of blocking solute particles having a size of about 0.01 microns or larger including, but not limited to proteins, emulsions, viruses, and/or bacteria.

The term “nanofiltration membrane” refers to any semi-permeable membrane capable of blocking solute particles having a size of about 0.001 microns or larger including, but not limited to, ions, sugars, proteins, emulsions, viruses, and/or bacteria.

In some embodiments, membranes are water-permeable. As used herein, “water-permeable” is use broadly and includes any mechanism by which liquid water or water vapor may pass through one side of the membrane to the other, inclusive of flowing through open pores, dissolving into the membrane and diffusing through (solution-diffusion), etc.

“Fouling” is the deposit or accumulation of unwanted material, such as living organisms or portions or bioproducts thereof (“biofouling”), onto a surface. Biofouling includes, but is not limited to, the growth of bacteria or biofilms on the surface, algae, etc.

“Biofilm” is a collection of microorganisms, typically bacteria, that adhere to surfaces, particularly surfaces submerged in or exposed to water, saline or wastewater. The bacteria are often embedded in a matrix of extracellular polymeric substances, commonly known as slime.

“Cleaning” as used herein is the reduction of fouling, either by decreasing the amount of material already on a surface, or reducing the amount of material that builds upon a surface by prevention of at least some of the accumulation. In some embodiments, cleaning may be accomplished by biocide activity, activity in reducing or damaging a biofilm slime (e.g., by changing bacteria into the planktonic state), some combination thereof, etc.

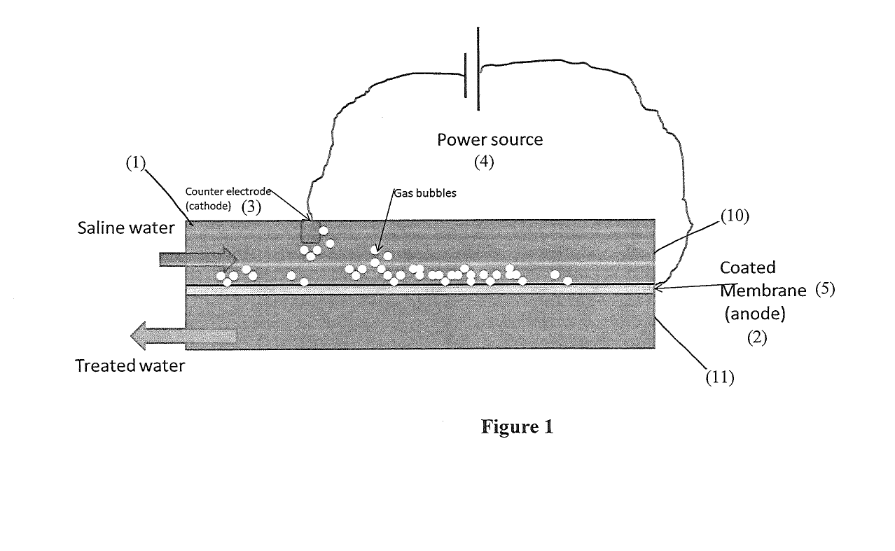

Provided herein is a water treatment unit, such as desalination module, that has an integrated electrochemical system. As shown in FIG. 1, the saline water in some embodiments acts as the electrolyte (1) in the electrochemical system. In addition to the electrolyte, components in the electrochemical system are the anode (2), the cathode (3) and an external power source (4). The system typically has at least two compartments, one into which saline water may be provided (10), and another (11) in which the desalinated water may be collected after passing through the membrane (5) situated therebetween. By coating the surface of the membrane (5) with an electrically conducting material, the membrane can perform as an anode, and the cathode can be, for example, any metallic insertion inside the electrolyte. A controller (6) (not shown) may be provided, which is operatively associated with the power source (4) and/or anode or cathode. The controller may allow the user to input settings to effect periodic application of the voltage to the system.

When voltage is applied to the system by the power source (4) shown in FIG. 1, water electrolysis will occur. In the electrolysis process, water will decompose into gases. The nature of the gases will depend on the chemistry of the saline solution and the applied voltage. At the cathode (3), it is expected that hydrogen gas evolution will occur, while at the anode (2) chlorine and O₂ gases will evolve.

In some embodiments, the quantities of gases produced may be minimized by applying the voltage periodically and/or for short periods just enough to prevent fouling or clean any foul occurring on the surface of the membrane. These periodical applications can be optimized as desired.

Various conductive materials may be used in the electrically conductive layer, including, but not limited to, electrically conductive ceramics (e.g., indium tin oxide (ITO), lanthanum-doped strontium titanate (STL), yttrium-doped strontium titanate (SYT), etc.), metallic materials (e.g., copper, silver, aluminum, platinum, etc.), and electrically conductive polymers such as nanotubes. The material may be coated (e.g., spray coated, chemical vapor deposition (CVD), physical vapor deposition (PVD), etc.), impregnated, etc., in a manner that preserves its ability to perform electrical conduction.

“Nanotubes” are cylindrical tubular structures that are of micrometer or nanometer scale. Nanotubes of a variety of materials have been studied, notably carbon nanotubes, boron nanotubes, and nanotubes of boron nitride. Those that have been most extensively studied are carbon nanotubes, whose features and methods of fabrication are illustrative of nanotubes in general. See, e.g., U.S. Pat. No. 8,177,979 to Ratto et al.

“Carbon nanotubes” are polymers comprised of carbon, and can exist as single-wall and multi-wall structures. Examples of publications describing carbon nanotubes and their methods of fabrication are Dresselhaus, M. S., et al., Science of Fullerenes and Carbon Nanotubes, Academic Press, San Diego (1996), Ajayan, P. M., et al., “Nanometre-Size Tubes of Carbon,” Rep. Prog. Phys. 60 (1997): 1025-1062, and Peigney, A., et al., “Carbon nanotubes in novel ceramic matrix nanocomposites,” Ceram. Inter. 26 (2000) 677-683. A single-wall carbon nanotube is a single graphene sheet rolled into a seamless cylinder with either open or closed ends. Multi-walled carbon nanotubes are two or more concentric cylinders of graphene sheets of successively larger diameter, forming a layered composite tube bonded together by van der Waals forces.

The present invention is explained in greater detail in the following non-limiting Examples.

### EXAMPLES

### Example 1

### Fabrication of Electrospun Membranes

Clear and uniform polymer solution of an appropriate amount of PVDF-HFP was prepared in a binary mixture of acetone and dimethylacetamide with a weight ratio of 7:3 using a magnetic stirrer at room temperature. PVDF-HFP solution was loaded in a 10 mL glass syringe with a luer lock steel tip connected to a stainless steel needle by a PTFE pipe. A Nanon-01A electrospining setup (MECC, Japan) was used for electrospining the polymer solution. The electrospining chamber had a relative humidity of 60±2% and temperature 25±1° C. A potential difference of 20-25 KV was generated between the needle and a rotating aluminum drum grounded target placed 15 cm from the tip of the needle. A solution feed rate of 1-2 ml h⁻¹ was used. The electrospun PVDF-HFP membranes were collected on the aluminum drum at 25° C. and dried at 50° C. for 24 hours in a conventional oven.

### Example 2

Coating Membranes in Example 1 with CNT

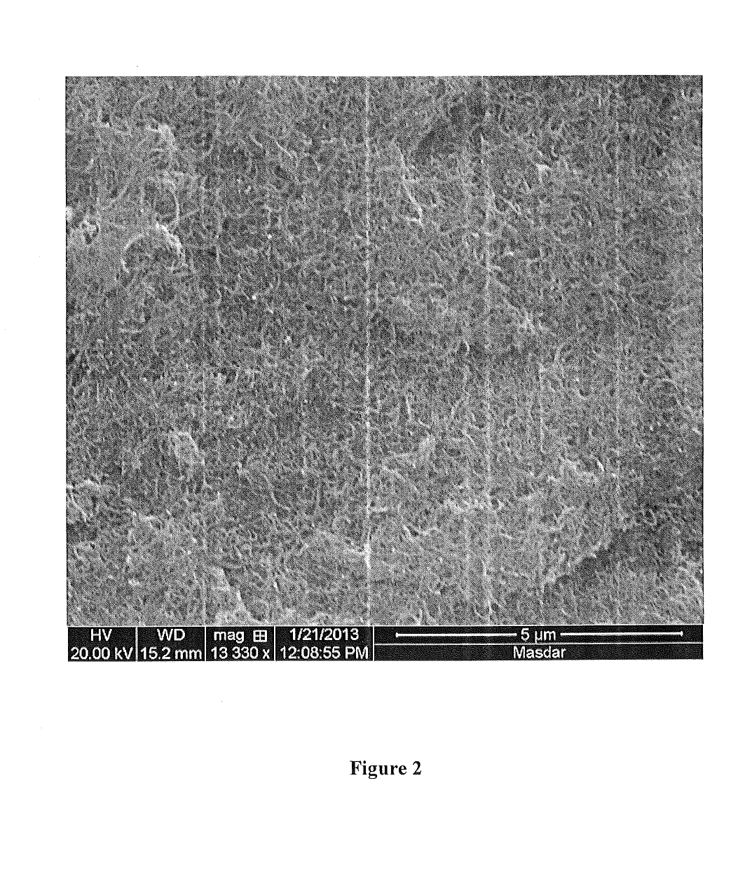

The electrospun membranes as prepared in example 1 were coated with multi-walled carbon nanotubes (MWCNTs) using electrospraying and vacuum filtration technique. In electrospraying method, suspension of MWCNTs was prepared in an appropriate solvent and electrospray on the membrane surface by applying a potential difference of 15-20 kV between the electrospraying needle and substrate. The thickness of the MWCNTs can be controlled by deposition time. In the other case, the MWCNTs were filtered through the electrospun membrane using vacuum filtration to form a thin surface film followed by drying at room temperature. After drying, coated membranes were annealed/hot pressed to fuse the MWCNTs inside the membrane matrix. At the end, membrane was washed with water to remove the unbounded MWCNTs from the surface of the membrane. The SEM image of the MWCNTs coated membrane is shown in FIG. 2.

### Example 3

### Fouling of Membrane

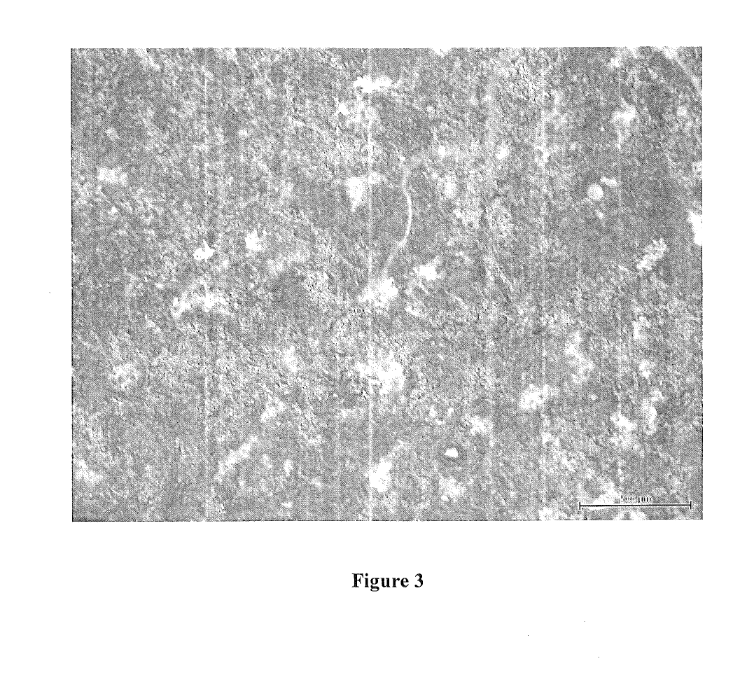

The membranes prepared in example 2 were dipped inside the wastewater taken from an anaerobic chamber and left for 24 hours to foul the membrane. The fouled membrane was removed from the wastewater and dried at room temperature for an hour. A clear fouling of the membrane was observed with the naked eye. The optical image of the fouled membrane is shown in FIG. 3.

### Example 4

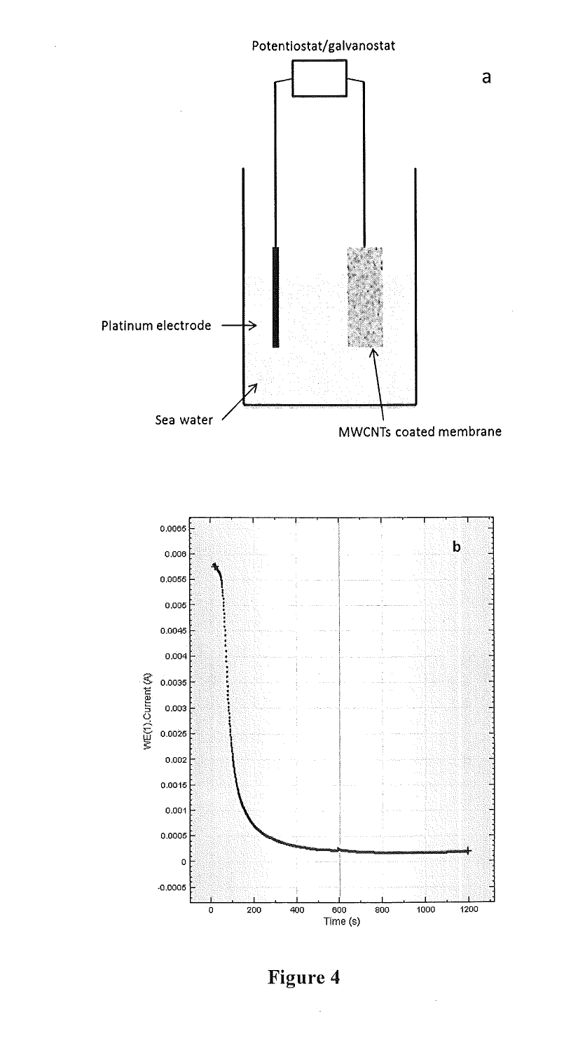

Set-Up Used for Membrane Electrolysis The schematic of the set-up used for electrolysis experiment is shown in FIG. 4a. The fouled membrane (example 3) was used as a working electrode, platinum wire was used as a counter and reference electrode dipped in the seawater procured from the Arabian Gulf acts as an electrolyte. The electrolysis was performed using Autolab potentiostat/galvanostat at 5 volt for 20 minutes. The current vs. time behavior of the electrochemical set up is shown in FIG. 4b.

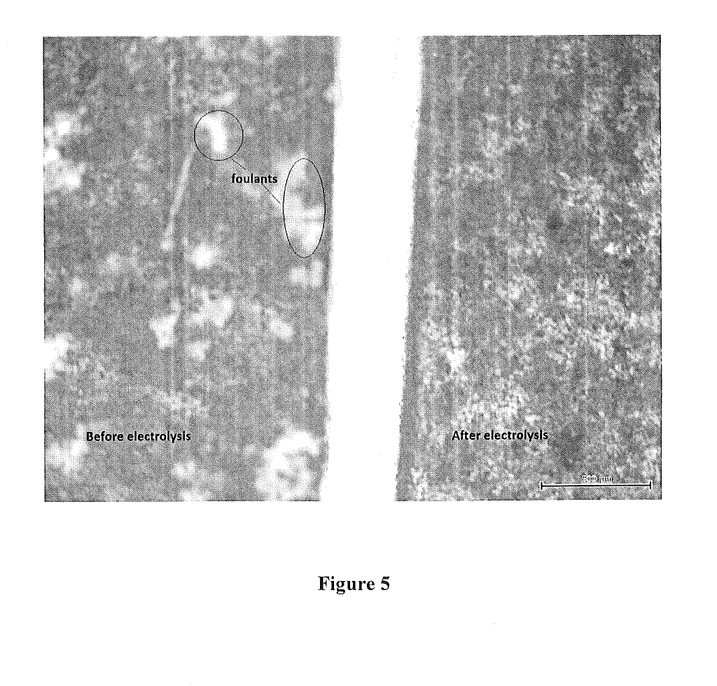

After electrolysis, fouled membrane was taken out from the electrolysis set-up and dried at room temperature. The optical image of the membrane surface before and after electrolysis is shown in FIG. 5. The results showed that the electrolysis of fouled membrane in seawater removes the foulants deposited on the membrane surface.

The foregoing is illustrative of the present invention, and is not to be construed as limiting thereof. The invention is defined by the following claims, with equivalents of the claims to be included therein. All publications, patent applications, patents, patent publications, and other references cited herein are incorporated by reference in their entireties to the extent they are consistent with the description presented herein.

We claim:

1. A system useful for desalination of saline water or wastewater, comprising:
a) at least two separate compartments having a semipermeable membrane situated therebetween, with one of said compartments configured for containing said saline water or wastewater, and the other of said compartments configured for containing or collecting desalinated water;
b) an electrically conductive layer on or in said membrane;
c) a power source connected to said conductive layer and configured so that said conductive layer is an anode; and
d) an electrode connected to said power source, with said electrode configured to be in fluid communication with said saline water or wastewater, and with said power source configured so that said electrode is a cathode,
whereby application of a voltage difference between said anode and said cathode in the presence of said saline water or wastewater generates a gas that cleans said membrane.

2. The system of claim 1, wherein said system further comprises a controller operatively associated with said power source.

3. The system of claim 1, wherein said membrane is a reverse osmosis, nanofiltration, membrane distillation, microfiltration, or ultrafiltration membrane.

4. The system of claim 3, wherein said system further comprises a controller operatively associated with said power source.

5. The system of claim 1, wherein said conductive layer is configured to be in fluid communication with said saline water or wastewater.

6. The system of claim 1, wherein said membrane is a water-permeable membrane.

7. The system of claim 1, wherein said membrane is an electrospun membrane.

8. The system of claim 1, where said conductive layer comprises carbon nanotubes.

9. The system of claim 1, wherein said conductive layer comprises multi-walled carbon nanotubes.

10. The system of claim 1, wherein said conductive layer comprises a metallic conductive material.

11. The system of claim 1, wherein said conductive layer comprises an electrically conductive ceramic.

12. A method of cleaning a desalination membrane, comprising:
providing an anode on said membrane, said anode in fluid communication with an electrolyte solution;
providing a cathode, wherein said cathode is also in fluid communication with said electrolyte solution; and
applying a voltage difference between said anode and said cathode to produce a gas on said anode sufficient to clean said membrane.

13. The method of claim 11, wherein said electrolyte solution is saline water or wastewater.

14. The method of claim 11, wherein said gas comprises oxygen and/or chlorine gas.

15. The method of claim 11, wherein said membrane is fouled by a biofilm coating thereon, and said gas is sufficient to remove at least a portion of said biofilm.

16. The method of claim 15, wherein said portion is at least 10, 20, 30, 40 of 50% of said biofilm coating.
